(19) United States
(12) Patent Application Publication
(10) Pub. No.: US 2026/0119685 A1
(43) Pub. Date: Apr. 30, 2026

(54) STORAGE AND PRESENTATION OF EVIDENCE DATA

(71) Applicant: GENETEC INC., Saint-Laurent (CA)

(72) Inventors: Christian HAMEL, Deux-Montagnes (CA); Nicholas MATHE, Cote Saint Luc (CA); Antoine MILLETTE, Laval (CA); Itai BOLYASNI, Pierrefonds (CA); Jeremy EL BEZ, Hampstead (CA); Said Mohamed DJAOUD, Longueuil (CA)

(21) Appl. No.: 18/931,506

(22) Filed: Oct. 30, 2024

(51) Int. Cl. G06F 21/62

(52) U.S. Cl. CPC G06F 21/6209; G06F 2221/2141

(57) ABSTRACT

The present disclosure provides methods and systems for enrolling a security device with a surveillance system. Secret information stored by the security device is accessed. A browser-based connection to the surveillance system is launched via the security device. The browser-based connection to the surveillance system is authenticated. After authenticating the browser-based connection, the secret information is provided to the surveillance system via the browser-based connection. The surveillance system is then made to enroll the security device.

### FIELD

The present disclosure relates generally to evidence management, and more specifically to techniques for storage and presentation of evidence data.

### BACKGROUND

Investigations into incidents such as criminal incidents, operational incidents, breaches of procedure, and the like, can involve the gathering of large amounts of information to be used as evidence in the investigation. Increasingly, the information gathered as part of an investigation includes digital evidence files (e.g., digital files such as video, audio, image or document files, hereinafter “DEFs”). An entity performing the investigation, which may be a law enforcement agency, a legal practice, or the like, may employ a digital evidence management system (DEMS) which stores DEFs, provides access thereto for investigators, and ensures that a proper chain of custody for the evidence is established and maintained.

An important part of any investigation is the construction of a clear and convincing narrative, whether for presentation to peers or to decision-makers, such as a jury, a prosecutor, a disciplinary committee, or the like. Such a narrative will necessarily rely on at least some of the evidence collected throughout the investigation, and the clarity and convincingness of a narrative will depend on presenting the evidence in a coherent manner. However, as the amount of evidence stored in the DEMS grows, the total body of evidence may become unwieldy and unfit for presentation in its totality.

Currently, investigators frequently build storytelling aids by downloading or exporting DEFs from their DEMS and importing them into separate software programs, including document processing programs, slideshow/presentation programs, and the like. Not only does this increase the security risks associated with exfiltration of the DEFs from the DEMS and improper storage thereof, including risking misappropriation of the DEFs, but it can also compromise the chain of custody for the DEFs which can affect their admissibility in court or as part of other proceedings.

Additionally, by extracting the digital evidence files from the DEMS, contextual information associated with the DEFs, stored as metadata associated with each DEF within the DEMS, may not be reproduced within the storytelling aid. Not only does this result in a loss of contextual information for the extracted DEFs, but any modifications to the metadata of a particular DEF, which might result in the DEF being recontextualized or understood differently, will not be replicated in the storytelling aid.

Thus, the existing approaches to constructing storytelling aids for investigations exhibit certain shortcomings, and improvements in investigation and storytelling tools may be desired.

### SUMMARY

The following presents a simplified summary of one or more implementations in accordance with aspects of the present disclosure in order to provide a basic understanding of such implementations, without limiting the embodiments presented within the present disclosure.

The present disclosure describes an investigation workspace to facilitate storytelling in an investigation. The investigation workspace is for use in conjunction with a DEMS, and may be integrated into the DEMS, or may be a standalone application that is in communication with the DEMS. The DEMS has as a first data repository, storing both a case database and one or more DEFs. The case database holds investigation records relating to investigations, and the DEFs may be stored in the same database or in a separate one within the DEMS. Each investigation record contains information relating to a particular investigation, and each DEF is associated with at least one of the investigation records and with a respective set of metadata which provides contextual information relating to the DEF.

An investigation workspace, used in creating storytelling aids, has a second data repository storing a database of storytelling aids, which includes a subset of the investigation records of the first case database, for instance only those investigation records which have been added to the investigation workspace. The second data repository can be used to store indications of one or more of the DEFs, stored in the first data repository, in association with the investigation records stored in the case database of the investigation workspace.

To ensure that any modifications to the DEFs made in the DEMS are shown in the investigation workspace, modifications to the metadata associated with the DEFs in the first data repository are detected. Then, the investigation workspace can display a pop-up or similar message displaying the relevant DEF and an indication of the modification to the metadata associated therewith, for instance to prompt an investigator using the investigation workspace to update a storytelling aid to incorporate the modifications to the metadata of the DEF.

In accordance with a broad aspect, there is provided a computer-implemented method for maintaining an investigation workspace. The method comprises providing a first data repository, which comprises a first case database including a set of records, each of the records in the set of records comprising case information related to an investigation; and a digital evidence database comprising one or more digital evidence files associated with at least one of the one or more records in the first case database, each of the one or more digital evidence files being associated with a set of metadata. The method also comprises providing a second data repository accessible by the investigation workspace, the second data repository comprising a storytelling aid database including data representative of a plurality storytelling aids and of a subset of records from the set of records of first case database, each storytelling aid associated with at least one record of the subset. The method further comprises storing in the second data repository an indication of a first digital evidence file in the digital evidence database of the first data repository, the first digital evidence file being associated with a first record in the subset of records in the second data repository; detecting a modification to the set of metadata associated with the first digital evidence file; and rendering, in a page in the investigation workspace associated with the first record, the modification to the set of metadata associated with the first digital evidence file.

In at least some embodiments according to any one or more of the previous embodiments, the rendering of the modification to the set of metadata associated with the first digital evidence file comprises displaying a subset of the set of metadata associated with the at least one digital evidence file.

In at least some embodiments according to any one or more of the previous embodiments, the method comprises rendering, in the page of the investigation workspace associated with the first record, a notification indicative of having detected the modification to the set of metadata associated with the first digital evidence file.

In at least some embodiments according to any one or more of the previous embodiments, rendering the notification comprises rendering, in the page in the investigation workspace associated with the first record, a graphical user interface (GUI) element indicative of the modification to the set of metadata associated with the first digital evidence file.

In at least some embodiments according to any one or more of the previous embodiments, the GUI element is indicative of audit trail information associated with the modification to the set of metadata associated with the first digital evidence file.

In at least some embodiments according to any one or more of the previous embodiments, the storing is performed in response to detecting user input indicative of a selection of the at least one digital evidence file within the investigation workspace.

In at least some embodiments according to any one or more of the previous embodiments, the selection is mediated by access control permissions associated with the user providing the user input.

In at least some embodiments according to any one or more of the previous embodiments, records in the subset of records included in the second case database are user selected in response to further user input within the investigation workspace.

In at least some embodiments according to any one or more of the previous embodiments, the indication of the first digital evidence file stored in the second data repository comprises a pointer.

In at least some embodiments according to any one or more of the previous embodiments, the pointer comprises a uniform resource locator (URL).

In at least some embodiments according to any one or more of the previous embodiments, the first data repository is accessible by a digital evidence management system and the method comprises, upon detecting further user interaction with the indication of the first digital evidence file, causing the first digital evidence file to be viewable in the digital evidence management system.

In at least some embodiments according to any one or more of the previous embodiments, the first data repository further comprises an audit trail database, and the method further comprises generating audit trail data indicative of the at least one digital evidence file having been linked in the second case database and storing the audit trail data in the audit trail database.

In at least some embodiments according to any one or more of the previous embodiments, the modification comprises an addition, a removal or a change to metadata in the set of metadata.

In at least some embodiments according to any one or more of the previous embodiments, the one or more digital evidence files comprise digital media files.

In at least some embodiments according to any one or more of the previous embodiments, the digital media files comprise video files, image files, audio files, or document files.

In accordance with another broad aspect, there is provided an investigation system. The investigation system comprises a digital evidence management system. The digital evidence management system provides a first data repository comprising: a first case database including a set of records, each of the records in the set of records comprising case information related to an investigation; and a digital evidence database comprising one or more digital evidence files associated with at least one of the one or more records in the first case database, each of the one or more digital evidence files being associated with a set of metadata. The investigation system also comprises an investigation workspace for use in generating storytelling aids, the investigation workspace providing a second data repository which comprises a storytelling aid database including data representative of a plurality storytelling aids and of a subset of records from the set of records of first case database, each storytelling aid associated with at least one record of the subset, the storytelling aid database storing an indication of a first digital evidence file in the digital evidence database of the first data repository, the first digital evidence file being associated with a first record in the subset of records in the second data repository. The investigation system further comprises an update module communicatively coupled to the digital evidence management system and to the investigation workspace. The update module is configured for: detecting a modification to the set of metadata associated with the first digital evidence file; and causing the investigation workspace to render, in a page in the investigation workspace associated with the first record, the modification to the set of metadata associated with the first digital evidence file.

In at least some embodiments according to any one or more of the previous embodiments, the update module comprises a dynamic data binder.

In at least some embodiments according to any one or more of the previous embodiments, the storing is performed in response to detecting user input indicative of a selection of the at least one digital evidence file within the investigation workspace.

In at least some embodiments according to any one or more of the previous embodiments, the selection is mediated by access control permissions associated with the user providing the user input.

In at least some embodiments according to any one or more of the previous embodiments, records in the subset of records included in the second case database are user selected in response to further user input within the investigation workspace.

### BRIEF DESCRIPTION OF THE DRAWINGS

For a more complete understanding of the present disclosure, reference is now made to the accompanying drawings. The following brief descriptions of the drawings should not be considered limiting in any fashion.

FIG. 1 is a block diagram of an example investigation system.

FIG. 2A is a graphical representation of an example digital evidence database.

FIG. 2B is a graphical representation of an example investigation records database.

FIG. 2C is a graphical representation of an example storytelling aids database.

FIG. 3 is a block diagram of another example investigation system

FIGS. 4A-B are screenshots of an example digital evidence management system.

FIGS. 5A-F are screenshots of an example investigation workspace tool.

FIG. 6 is a block diagram of an example computing system.

FIG. 7 is a flowchart illustrating an example method for maintaining an investigation workspace.

It will be noted that throughout the appended drawings that like features are identified by like reference numerals.

### DETAILED DESCRIPTION

While many motivations may exist for launching an investigation, one common goal of an investigation is to explain, in a clear and convincing manner, a sequence of events, as well as their actors, locations, and consequences. An investigator may need to present the results of the investigation to a judge, a jury, a disciplinary committee, a group of executives, or any other such stakeholders. And, although most investigations begin with the collection of evidence, different investigators may be tasked with different portions of the investigation. Moreover, the pieces of evidence, as collected, are rarely obtained in the same chronological order as the events relevant to the investigation. For an investigator tasked with presenting the results of the investigation, merely presenting the evidence as collected may not be conducive to providing the clear and convincing narrative required to satisfy the relevant stakeholders, both because the evidence may be gathered in an unstructured manner, and because the order of relevant event themselves may not be the most conducive to providing a structured narrative. To this end, an investigator may make use of an investigation workspace tool to produce storytelling aids, which are visual and/or auditive displays which arrange the evidence gathered as part of the investigation in a fashion suitable for explaining a sequence of events, actors in those events, the locations where those events occurred, and the like, in a clear and convincing manner.

A storytelling aid may allow an investigator to arrange, visually and/or temporally, various elements of evidence to facilitate understanding of the events of interest in an investigation, thereby enabling the investigator to better explain the results of an investigation. By way of an example, the investigator may arrange events in a temporally linear fashion along a horizontally spanning timeline, to indicate an order of progression of events. By way of another example, a mugshot or other photograph of a principal actor in an event may be placed in a central location of the storytelling aid, with photographs of supporting actors, key locations, or images of actions performed by the various actors being displayed around the photograph of the principal actor. Other approaches for arranging various elements of evidence may also be employed when producing a storytelling aid.

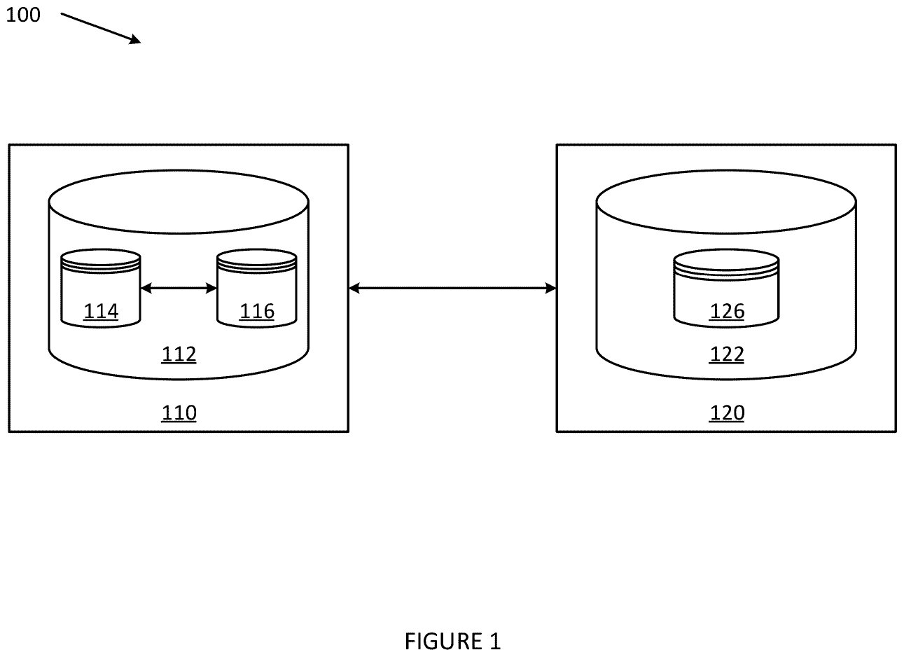

With reference to FIG. 1, as most modern investigations rely at least in part on digital evidence, the present disclosure will focus on a computer-based investigation system, referred to below as an investigation system 100, which includes at least a digital evidence management system (DEMS) 110 and an investigation workspace 120, which are both configured to utilize digital evidence files (DEFs). DEFs may include any suitable type of digital data, including video data, audio data, image data, textual data, or combinations thereof (e.g., spreadsheets, slideshows, etc.), and may be stored in any suitable format or as part of any suitable data structure. Various techniques for transforming analog evidence into digital evidence may be employed for facilitating the incorporation of such analog evidence into the DEMS 110. The DEMS 110 and the investigation workspace 120 are in communication with one another, in order to share information therebetween, as will be described in greater detail hereinbelow.

In some embodiments, at least part of the DEFs composing the evidence associated with an investigation may be obtained from a security system, which may employ one or more security cameras, one or more access control devices, and/or other sensors for obtaining security or operational data relating to a location being monitored. The investigation system 100 may form part of the security system or may be separate therefrom whilst being communicatively coupled thereto for exchanging information, including DEFs, therewith. Additionally, in some embodiments, the investigation system 100 may be configured for obtaining information from other sources, including information uploaded by an operator of the investigation system 100 (e.g., an investigator), from third parties wishing to share evidence relating to an investigation, or the like.

The DEMS 110 implements a data repository 112, which may be used to store various types of data in any suitable fashion. In some embodiments, the data repository 112 implements a digital evidence database 114 and a case records database 116 as separate databases, as illustrated in FIG. 1. In some other embodiments, the digital evidence database 114 and the case records database 116 may be implemented in a common database, as appropriate. Although the present disclosure will focus primarily on evidence stored in the DEMS 110, including the various DEFs described herein, it should be understood that the data used to construct storytelling aids, or otherwise available to the investigation workspace 120, may be obtained from other sources, including but not limited to, information available as part of a broader security system, such as video data, access control and intrusion data, license plate recognition data, and the like.

The investigation workspace 120 provides functionality for creating storytelling aids, to facilitate investigators in presenting evidence relating to investigations in a clear and convincing manner. The investigation workspace 120 implements a data repository 122, which in turn implements a storytelling aids database 126. It should be understood that the DEMS 110 and the investigation workspace 120 may include other elements, including graphical user interfaces (GUIs), communication interfaces, processing functionality, for instance for storing, securing, and auditing access to information, and the like.

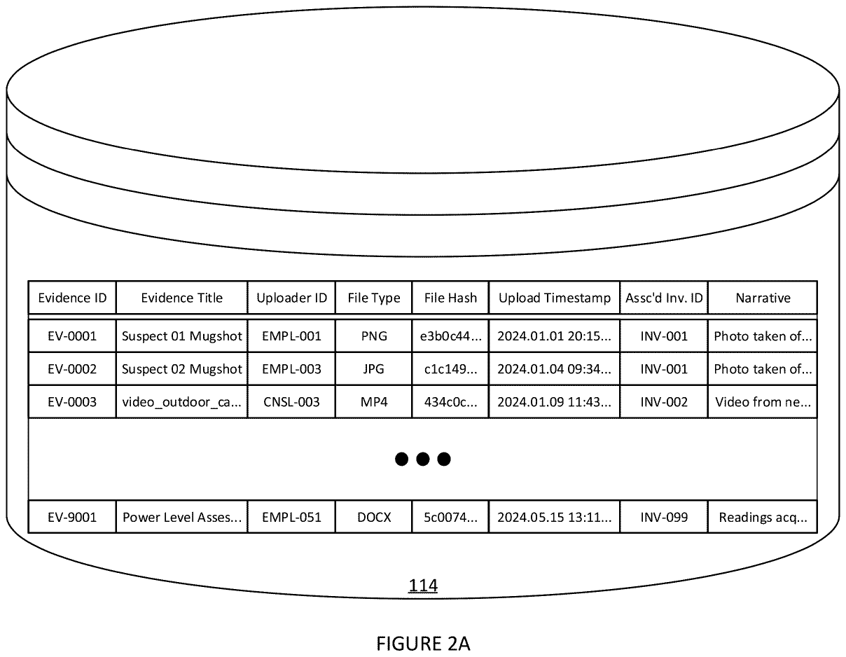

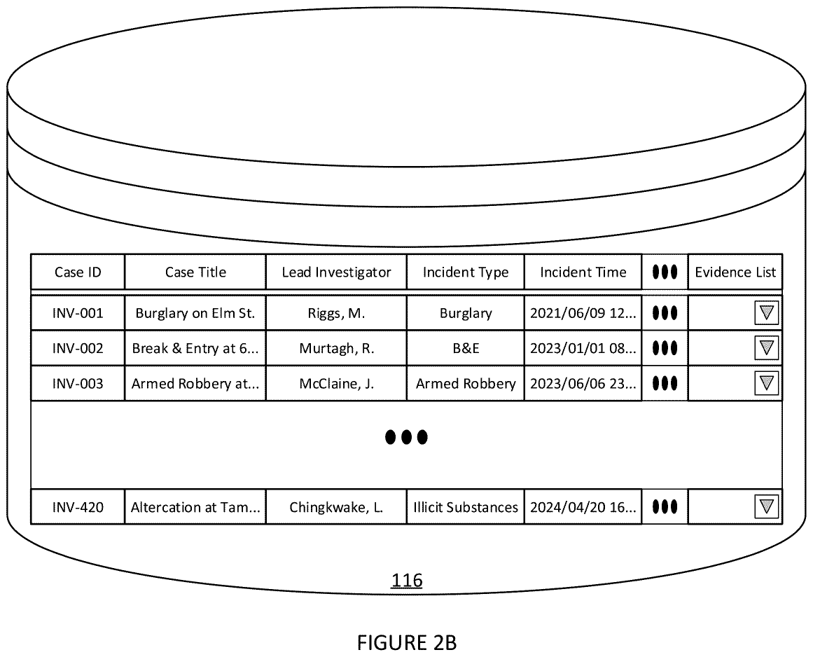

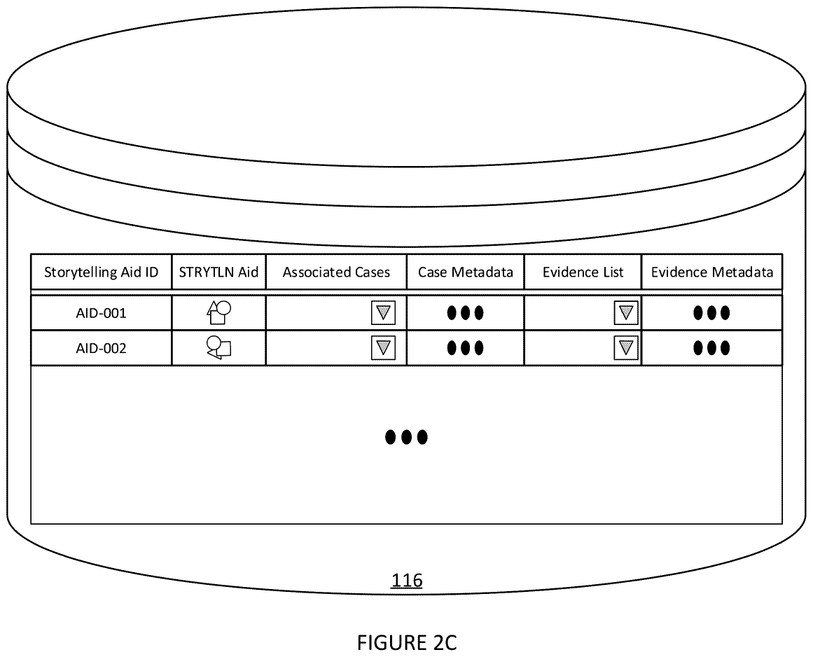

With additional reference to FIG. 2A, the digital evidence database 114 serves to store various DEFs, which may relate to any number of investigations, including concluded investigations, ongoing investigations, and future or planned investigations. The digital evidence database 114 may store the DEFs in any suitable format and data structure, though in some embodiments the digital evidence database 114 stores the DEFs to ensure that a proper chain of custody of the DEFs is preserved. This may include maintaining audit trail data which details accesses to the DEFs, including information regarding the upload, modification, deletion, transfer, etc. of the DEFs stored in the digital evidence database 114, and of which users performed those operations, allowing or preventing access to the DEFs based on user access permissions, and the like.

The digital evidence database 114 stores, in association with each of the DEFs, respective sets of metadata which serve to describe and provide context and/or other information relating to their respective DEF. As illustrated in FIG. 2A, a first DEF, assigned Evidence ID EV-0001, may be titled “Suspect 01 Mugshot” (it should be understood that the particular format of the Evidence ID may be varied as appropriate). In addition to the Title, other metadata may be associated with EV-001, including an Uploader ID field (indicating the user who uploaded the DEF), a File Type field, a File Hash field (which may be used for auditability and data integrity), an Upload Timestamp field (indicating the time at which the DEF was uploaded), and the like. The digital evidence database 114 may also store an indication of which investigation the DEF is associated with in an Associated Investigation ID field, as well as a Narrative field which may allow an investigator to enter freeform text describing the DEF.

It should be understood that the digital evidence database 114 may store any suitable amount of metadata in association with each of the DEFs, including metadata fields not explicitly illustrated in FIG. 2A. By way of some non-limiting examples, the digital evidence database may include an identifier of the source of the evidence (e.g., a device ID), an identifier of other devices related to the source (e.g., a vehicle identifier for a vehicle associated with a source mobile camera), a transcript of any audio associated with the DEF, or the like. In addition, a DEF may be associated with multiple investigations; this may be done by storing multiple associated investigations in the Associated Investigation ID field, by the digital evidence database 114 having multiple Associated Investigation ID fields, or in another suitable fashion.

The metadata stored in the digital evidence database 114 may be obtained from a variety of sources. In some cases, part or all of the metadata stored in the digital evidence database 114, in association with each of the DEFs, may be obtained as part of the process for obtaining the DEFs themselves; in other words, the metadata for a particular DEF may be obtained alongside the DEF, from the same source as the DEF itself. For instance, a DEF may be a portion of a video captured by a security system, and the security system may, concomitantly with the production of the video, determine the file type, file hash, a time and location of capture, and other relevant metadata.

In some cases, part or all of the metadata stored in the digital evidence database 114 may be obtained during the process of storing the DEF in the digital evidence database 114. For instance, the Uploader ID, Upload Timestamp, and Associated Investigation ID may be obtained by the digital evidence database 114 in the process of storing the DEF in the digital evidence database 114, for instance via a GUI or other input mechanism associated with the DEMS, which may allow an investigator or other user of the investigation system 100 to specify various information relating to the DEF that is thereafter stored in the digital evidence database 114 as part of the metadata associated with the DEF.

In some cases, part or all of the metadata stored in the digital evidence database 114 may be obtained after the DEF is stored in the digital evidence database 114. For instance, once a particular DEF is stored in the digital evidence database 114, an investigator or other user of the investigation system 100 may use the DEMS 110 to access the particular DEF. The DEMS 110 may be configured for presenting a GUI to the investigator or other user of the investigation system 100 to present the DEF and the various metadata elements stored in association therewith. The GUI may then allow the investigator to add, remove, or modify one or more of the metadata elements, for instance allowing the investigator to modify the Narrative metadata field to include other information describing the particular DEF. In some further cases, part or all of the metadata stored in the digital evidence database 114 may be acquired via other means and/or at other times, as appropriate. A record of these actions may also be stored by the DEMS 110 for audit purposes.

With additional reference to FIG. 2B, the case records database 116 is used to store a set of records of cases at various stages of investigation (whether ongoing, closed, or as-of-yet unopened). Each case is associated with a Case ID, which serves to uniquely identify each investigation, although the particular format of the Case ID may be varied as appropriate. Each case is also associated with other information elements, which may be considered metadata. In the illustrated example in FIG. 2B, cases are associated with a Case Title, a Lead Investigator (which, while identified here by a last name and first initial, may be stored in any other suitable fashion, for instance an employee number or other identification number), an Incident Type, and Incident Time. Other information may also be stored in association with the cases, such as the location of the incident, the office or department responsible for the investigation, a list of persons of interest for the investigation, and the like. Additionally, the case records database 116 may store a list of evidence associated with the case, which may be a listing of the DEFs, stored in the digital evidence database 114, which are associated with a particular case. The Evidence List field may store information in any suitable fashion, for example a listing of Evidence IDs, links or pointers to the DEFs in the digital evidence database 114, or the like. It should be understood that the case records database 116 does not itself store the DEFs listed in the Evidence List: the case records database 116 stores only references to the DEFs, which are stored instead in the digital evidence database 114.

Returning to FIG. 1, and with additional reference to FIG. 2C, the storytelling aids database 126 is used to store a set of storytelling aids produced using the investigation workspace 120. As mentioned hereinabove, the investigation workspace 120 is used, inter alia, to produce storytelling aids. The investigation workspace 120 may present a GUI or other interface via which the investigator can produce storytelling aids which include a visual and/or temporal arrangement of the DEFs associated with the cases present in the storytelling aids databases 126. Producing the storytelling aid may involve using a mouse, touchscreen, or other input device coupled to the investigation workspace 120 to visually arrange graphical representations of the DEFs on a screen or other output device coupled to the investigation workspace 120, or using a mouse, keyboard, or still other input devices coupled to the investigation workspace 120 to provide configuration data to the investigation workspace 120 for the storytelling aid.

Each storytelling aid stored in the storytelling aid database 126 is associated with a unique identifier. The storytelling aids may be stored in any suitable format, which may vary depending on the implementation. For instance, the investigation workspace may be a web-based tool, and may store storytelling aids as a combination of HTML and CSS, or XML data. By way of another example, the storytelling aids database 126 stores the storytelling aids as a JSON or other data file. In addition, the storytelling aids database 126 stores a list of one or more cases to which the storytelling aid is associated. In this fashion, the storytelling aids database 126 also stores a set of records of cases for which the investigation workspace 120 is being used. In some embodiments, the storytelling aids database 126 also stores authentication data used to ensure the integrity of the storytelling aids stored therein. In some embodiments, storytelling aids may be linked together, such that the arrangement of DEFs across multiple storytelling aids are appended, joined, or otherwise connected to be viewed together. In this fashion, a storytelling aid may be composed of multiple sub-storytelling aids, which together form one larger, more complete storytelling aid. Information about linked storytelling aids may also be stored in the storytelling aid database 126.

As not every investigation will necessarily require a storytelling aid, not every case present in the case records database 116 will be present in the storytelling aids database 126; as a result, the storytelling aids database 126 stores a subset of the records stored in the case records database 116. For those cases of the case records database 116 that are present in the storytelling aids database 126, the case information and other metadata stored in the storytelling aids database 126 may mirror that of the case records database 116. For example, when an investigator using the investigation workspace 120 decides to work on a storytelling aid, the investigator may select one of the cases already listed in the storytelling aids database 126; if the storytelling aid is for a case not present in the storytelling aids database 126, the investigator may select one of the cases in the case records database 116, resulting in a new entry being added in the associated cases list for the particular storytelling aid, based on the information in the case records database 116.

Additionally, the storytelling aids database 126 may store a list of evidence associated with the one or more associated cases, which may be a listing of the DEFs, stored in the digital evidence database 114, which are associated with the one or more cases associated to the particular storytelling aid. The Evidence List field may store information in any suitable fashion, for example a listing of Evidence IDs, links or pointers to the DEFs in the digital evidence database 114, or the like. By way of an example, the pointers used may include uniform resource locators (URLs), symbolic links, application pointers, or other types of links. By way of another example, the pointers used may include a hash value for the DEF, which may be used to locate the DEF within the DEMS 110. It should be understood that, just like the case records database 116, the storytelling aids database 126 does not itself store the DEFs listed in the Evidence List: the storytelling aids database 126 stores only references to the DEFs, which are stored instead in the digital evidence database 114.

As noted hereinabove, the case records database 116 does not itself store any DEFs; rather, each investigation is stored in association with a list of evidence, storing one or more indicators referencing the DEFs stored in the data repository 112. Similarly, the storytelling aids database 126 also stores a list of evidence, which includes one or more indications which reference the DEFs stored in the digital evidence database 114. In some embodiments, the storytelling aids database 126 may store a copy of the metadata associated with the DEFs present in the evidence list for each storytelling aid. As the metadata is separate from the DEFs, but nevertheless provide useful information relating thereto, storing a copy of the metadata may be accelerate access to the metadata when working in the investigation workspace 120 whilst maintaining the chain of custody and other data protections regarding the DEFs. In addition, as the metadata may be comparatively lightweight, from a data perspective, compared to the DEFs themselves, there may not be a significant cost associated with storing a copy of the metadata in the storytelling aids database 126.

The storytelling aids produced using the investigation workspace 120 only arrange graphical representations of the DEFs, and do not copy the DEFs themselves, or their storage. This ensures that any modifications made to the DEFs, including to the metadata associated with each of the DEFs, does not require a separate operation to ensure replication in the case records database 116 and/or the storytelling aids database 126. Instead, when modifications are made to a particular DEF, for example to update the associated Narrative field, the Evidence List field in the case records database 116 and or the storytelling aids database 126 does not need to be modified, and still reflects the modification to the particular DEF in the digital evidence database 114.

In this fashion, updating the Narrative field of the particular DEF does not cause the storytelling aid in the investigation workspace 120 to become out of date, since the storytelling aid does not store a copy of the DEF, but instead points directly to the DEF as stored in the digital evidence database 114, and any modification made to the DEF in the digital evidence database 114 is reflected in the storytelling aid. This ensures data consistency between the DEMS 110 and the investigation workspace 120, avoids the need to constantly copy and recopy data between the DEMS 110 and the investigation workspace 120, and maintains the chain of custody and data protection of the DEFs within the DEMS 110. In embodiments in which the storytelling aids database 126 stores a copy of the metadata associated with the DEF, this copy may be updated in accordance with the embodiments described herein.

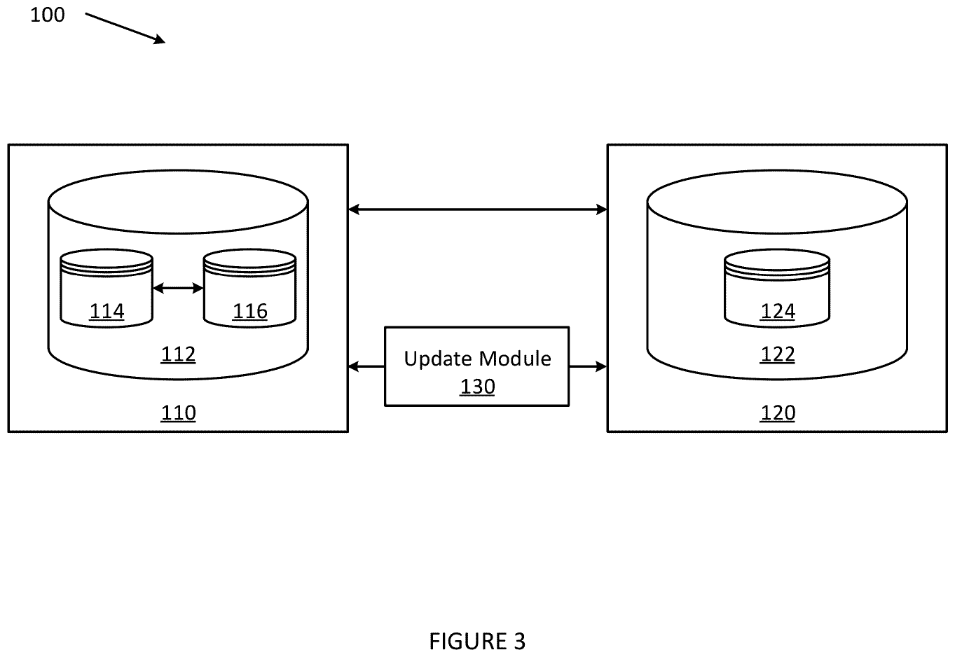

With reference to FIG. 3, in some embodiments, the investigation system 100 includes an update module 130, which is communicatively coupled to the DEMS 110 and the investigation workspace 120. In some embodiments, including the embodiment illustrated in FIG. 3, the DEMS 110 and the investigation workspace 120 are also coupled to one another, though in some other embodiments, the update module 130 may be configured for mediating all communications between the DEMS 110 and the investigation workspace 120. In addition, even though the embodiment illustrated in FIG. 3 shows the update module as being separate from the DEMS 110 and the investigation workspace 120, it should be understood that in some embodiments, the update module 130 may be part of the DEMS 110, part of the investigation workspace 120, or distributed between both the DEMS 110 and the investigation workspace 120.

The update module 130 is configured for monitoring the DEMS 110 to detect modifications to the DEFs stored in the digital evidence database 114, including the addition of DEFs, the association of DEFs with cases stored in the case records database 116 (whether with existing cases or with new cases), additions or modifications of metadata entries associated with each of the DEFs, deletions of DEFs and/or of associated metadata, and the like. In some embodiments, the update module 130 is implemented as, or using, a dynamic data binder, which ensures that the data relating to the DEFs within the investigation workspace 120 remains up-to-date when the source of the DEFs, namely the DEMS 110, is updated. In some embodiments, another suitable mechanism, that serves to link GUI elements to source data, is employed, such that changes to the data can be reflected in the user interface whilst allowing remainder portions of the user interface to remain static.

Thus, as modifications are made to the DEFs and/or their associated metadata, the update module 130 may track these modifications. In some embodiments, the update module 130 includes, or is associated with, a memory which may be used to store a list of all the modifications to the DEFs and/or their associated metadata. In some embodiments, the memory of or associated with the update module 130 keeps a list of all the DEFs and/or associated metadata entries which have been modified, without explicitly storing the nature of those modifications. Other approaches are also considered.

By tracking the modifications to the DEFs and/or their associated metadata, or by tracking which of the DEFs and/or their associated metadata are modified, users of the investigation workspace 120 can be notified of the modifications made to the DEFs and/or their associated metadata by the update module 130. In some embodiments, rather than directly updating storytelling aids in response to modifications to the DEFs and/or to their associated metadata, users of the investigation workspace 120 may be alerted in response to modifications in the DEFs and/or to their associated metadata. In addition, in embodiments in which a copy of the metadata associated with the relevant DEFs is stored in the storytelling aids database 126, the update module 130 may directly update the metadata copy, or prompt the user to update the metadata copy in response to the update. As will be described in greater detail hereinbelow, the users of the investigation workspace 120 may be alerted by way of suitable GUI elements.

For example, when an entry in the DEMS 110 comprising an image is updated to modify the metadata associated with the image—for instance, to add a listing of subjects visible in the image, to associate the image with a timestamp and/or a location of capture, or the like—the update module 130 can identify the modification made to the DEMS 110 entry. A record of the modification (or an indication of the DEMS 110 entry) can be stored by the update module 130, and when a user of the investigation workspace 120 next accesses a storytelling aid which includes the DEMS 110 entry, the update module 130 may indicate to the investigation workspace 120 that the DEMS 110 entry has been modified. The investigation workspace 120 may then present a GUI element to the user to indicate the modification in the DEMs 110 entry, or can automatically proceed to updating the storytelling aid to reflect the change made to the DEF and/or to its associated metadata.

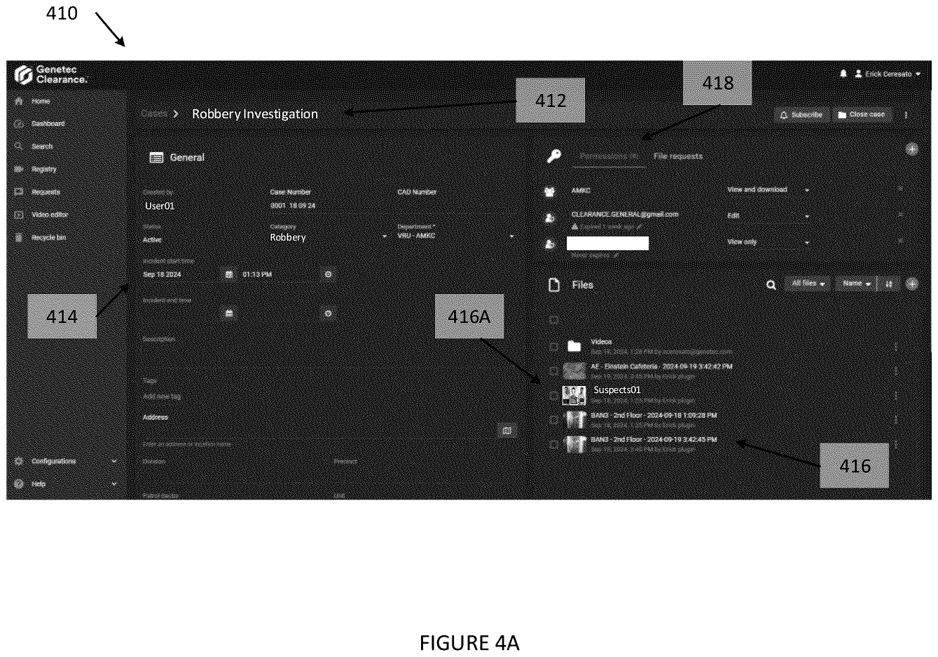

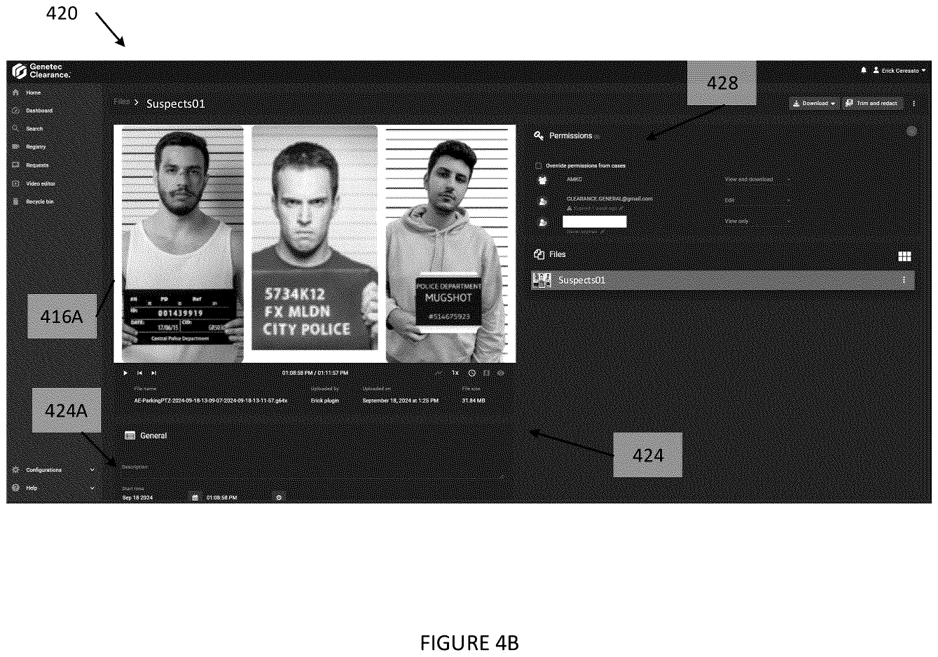

With reference to FIG. 4A, there is illustrated a GUI for an example case management page 410 of DEMS, for instance the DEMS 110. The case management page 410 may be one of a plurality of pages, each with their own GUI, as appropriate, which the DEMS 110 can present to a user of the DEMS 110 to facilitate the management of DEFs, including their association with various investigations. The case management page 410 may allow a user of the DEMS to add, modify, remove, and otherwise review DEFs associated with the case, metadata associated with the DEFs, and information relating to the case itself, in the form of metadata.

As illustrated in FIG. 4A, the case management page 410 may indicate a title 412 for the case, various case metadata 414, a listing 416 of evidence (also referred to as DEFs 416) associated with the case, and provide information on permissions 418 associated with the case. The case metadata 414 may include a unique identifier of the case (i.e., a case number), an identity of the creator or owner of the case, information relating to the relevant times and/or places relating to the case, a description of the case, tags or categorizations, and other information, as appropriate. The user may interact with the case management page 410 to add, remove, or modify the case metadata 414.

The case management page 410 also presents the listing 416 of DEFs associated with the case. As mentioned hereinabove, the DEFs may include various types of files, including video, audio, text, images, and the like: in the embodiment of FIG. 4A, the listing 416 includes a folder of video files and a plurality of images, though in other embodiments, the listing 416 could include other DEFs. The case management page 410 may also allow a user to review and modify permissions 418 associated with the case and/or the DEFs associated with the case, for instance to preserve chain of custody, to ensure compliance with local regulations, and the like. In some cases, different users may have different permissions for accessing the DEFs, other case information, for building storytelling aids using the DEFs, and the like.

The case management page 410 may permit a user to interact with the DEFs in the listing 416, for instance using a mouse or other pointing device. With additional reference to FIG. 4B, following interaction with one of the DEFs, for instance DEF 416A, the DEMS 110 may present an evidence management page 420. Within the evidence management page 420, the DEF 416A may be presented alongside evidence metadata 424 pertaining to the DEF 416A and permissions 428 associated with the DEF 416A. The evidence metadata may include any suitable type of information relating to the DEF 416A, as described hereinabove in relation to the digital evidence database 114. The permissions 428 may dictate which users are allowed to access the DEF 416A, to modify the contents of the evidence metadata 414, to delete the DEF 416A, and/or to include the DEF 416A in a storytelling aid. The permissions 428 may be implemented in any suitable fashion, using any suitable access controls.

Provided a user has the appropriate permissions, the user may add, remove, or otherwise modify the evidence metadata 424 for the DEF 416A. By way of an example, by interacting with the Description field 424A, a user could provide user input (e.g., textual input, audio input, video input, etc.) to serve as a description of the DEF 416A. In the illustrated example in FIG. 4B, a description might be “Mugshots of suspects apprehended 2023.12.01 outside jewelry store. Names are <redacted>”, which could be entered via a keyboard, a speech-to-text application, or the like. As described herein, when the user of the DEMS makes a change to the DEF 416A, for instance to introduce a description into the Description field 424A, any storytelling aids which employ the DEF 416A may similarly be updated to reflect the change made within the DEMS 110 in the investigation workspace 120.

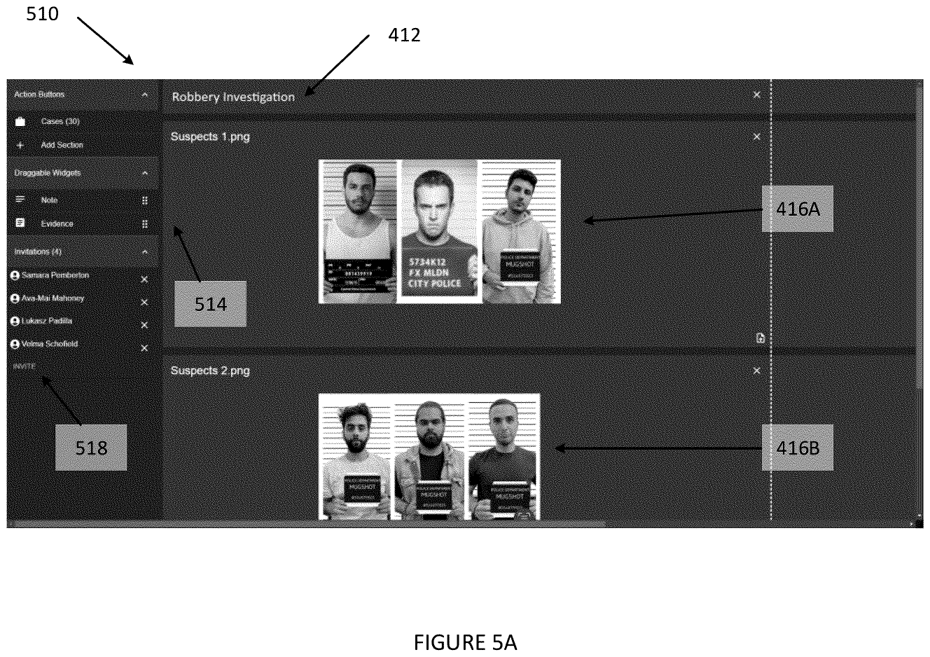

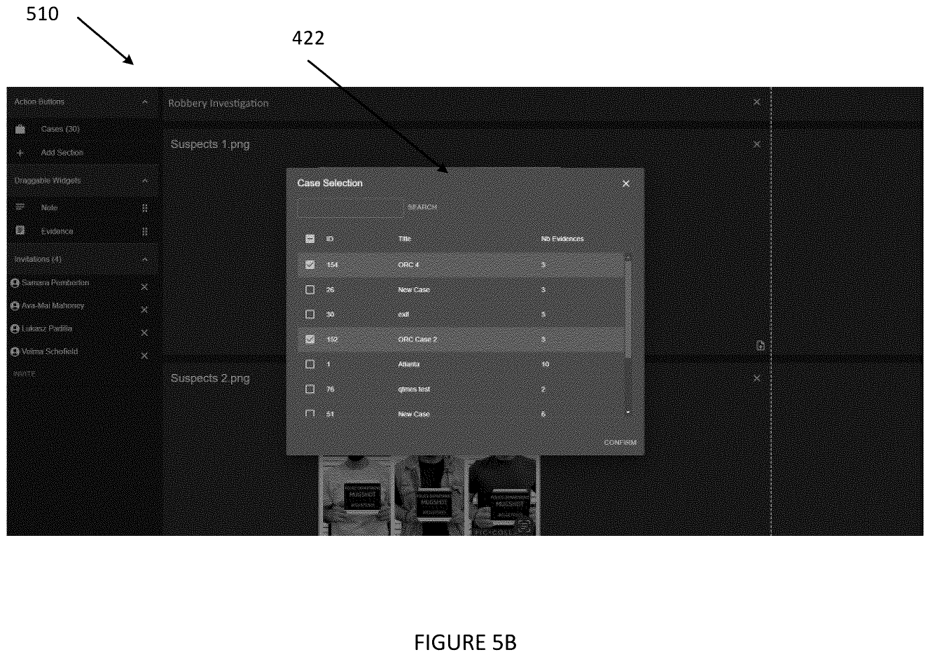

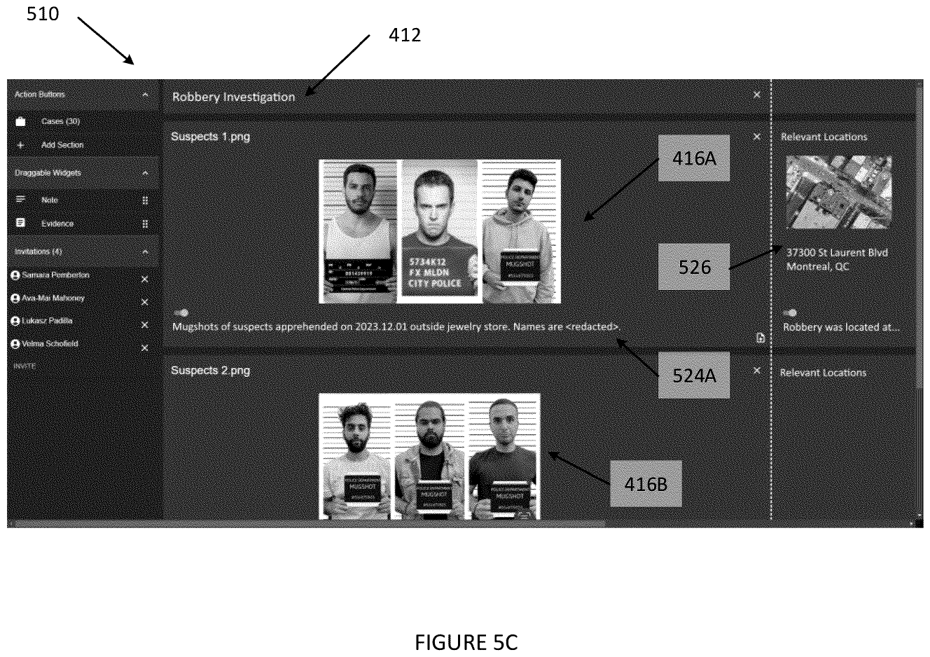

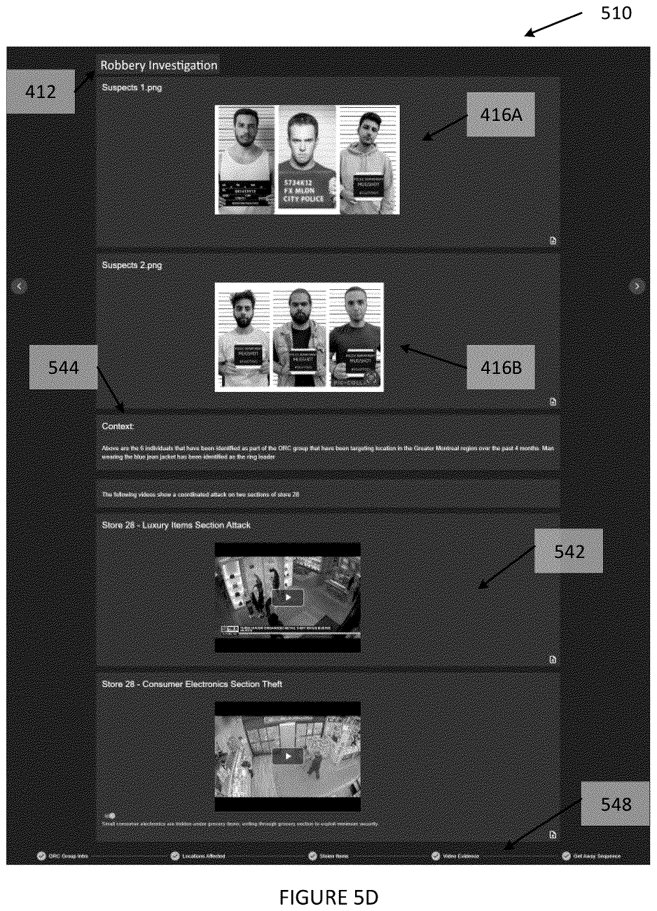

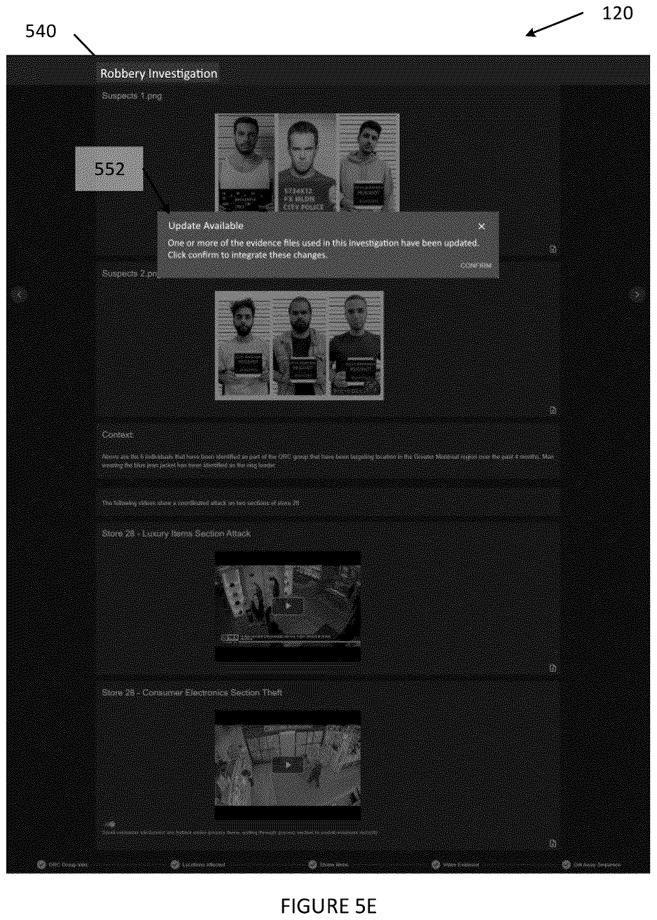

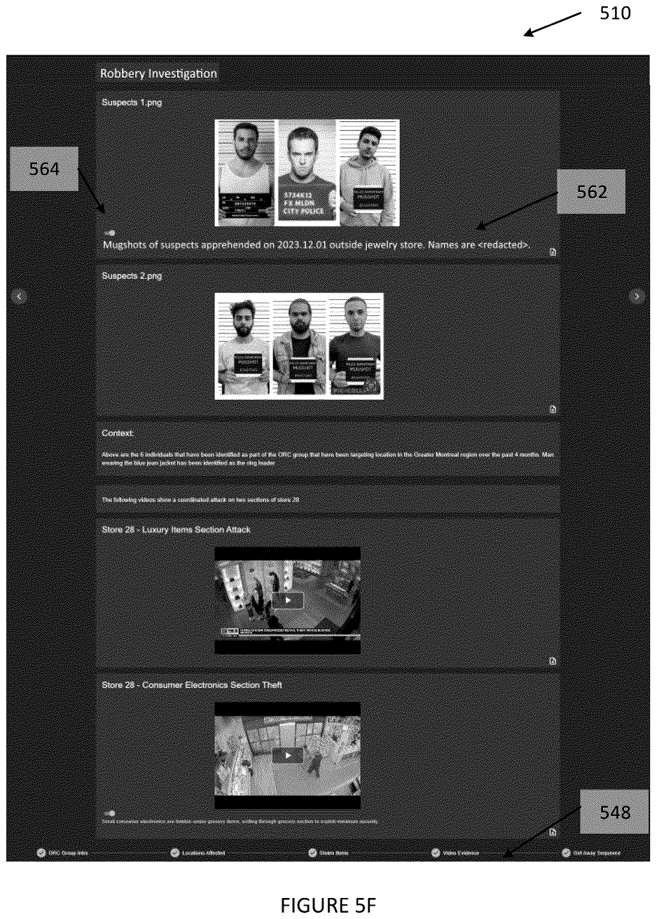

With reference to FIG. 5A, the investigation workspace 120 may allow a user to create a storytelling aid 510 using, inter alia, the DEFs 416 associated with the case illustrated in FIG. 4A, titled “Robbery Investigation”. To create the storytelling aid 510, or to modify an existing storytelling aid, the investigation workspace 120 may provide a project mode, as illustrated in FIG. 5A, in which the operator can select DEFs from the DEMS 110 to include in the storytelling aid 510. In the illustrated embodiment of FIG. 5A, as the storytelling aid 510 is associated with the same case as was shown in the case management page 410 of FIG. 4A, the storytelling aid 510 therefore shows the same title 412.

In project mode, the user may freely add, remove, and rearrange the DEFs 416. The selection of a DEF of the listing 416 to include in the storytelling aid 510 results in the creation of an indication of that DEF within the storytelling aid database 126, as described herein; the DEF is not copied from the DEMS 110 into the investigation workspace 120. In order to add a DEF to the storytelling aid 510, the user must have the appropriate permissions 418, as detailed in the case management page 410. If a user without the appropriate permissions 418 attempts to add or remove a DEF from the storytelling aid 510, the action may be refused.

In the example illustrated in FIG. 5A, the DEF 416A shown in FIG. 4A-B is one of the included DEFs; additionally, the storytelling aid includes the DEF 416B and may include any other suitable DEFs. In some cases, project mode allows a user to select one or more widgets which represent categories of the DEFs 416. For instance, a “video” widget may cause one or more of the video files in the listing 416 to be added to the storytelling aid 510. Similarly, a “notes” widget may cause written notes, which may be part of the DEFs 416 or the case metadata 414, to be added to the storytelling aid 510.

In order to share the storytelling aid 510, various sharing GUI elements 518 may be present in project mode. This may include a listing of users with which the storytelling aid may be shared, as well as an Invite button which may allow a user to enter one or more names, email addresses, or other identifiers of persons or entities with which the storytelling aid is to be shared. Sharing the storytelling aid 510 involves providing access for another user to access and/or modify the storytelling aid 510; the storytelling aid 510 is not copied or exported and then provided to the other user, as this would result loss of chain of custody and data protection associated with the DEMS 110.

With additional reference to FIG. 5B, in project mode, the user of the investigation workspace 120 may visualize a list of cases with which various DEFs are associated, in order to locate the appropriate DEFs to add to the storytelling aid 510. For instance, upon selecting a GUI icon in project mode, the investigation workspace 120 may cause a case selection pane 422 to be overlaid over the storytelling aid 510 which details a listing of the cases present in the storytelling aid database 126 and/or the case records database 116. By interacting with the case selection pane 422, the user may identify other cases to associate with the storytelling aid 510, which may then be reflected in the storytelling aid database 126, in order to link to DEFs associated with those cases, or to disassociate the storytelling aid 510 with one or more of the cases which may no longer be necessary for building the storytelling aid 510.

With additional reference to FIG. 5C, when a user makes a change to the DEF 416A, for instance to include a description in description field 424A, these changes may be reflected in the storytelling aid 510, for instance by action of the update module 130. Thus, when the description field 424A is changed, the representation of the DEF 416A within the storytelling aid 510 may be modified to include a description 524A. Similarly, if the evidence metadata 424 is changed in another fashion, for instance to add a location associated with the DEF 416, location information 526 may be added to the representation of the DEF 416A in the storytelling aid 510. The change to the representation of the DEF 416A within the storytelling aid 510 may occur substantially in real-time with the change made to the DEF 416 within the DEMS 110, at some delay relative thereto, or at any other suitable time. For example, the update module 130 may periodically review the digital evidence database 114 to identify changes to the DEFs stored therein, and may update the storytelling aid 510 in response to identifying the change to the 416A.

With reference to FIG. 5D, once the user has finished editing the storytelling aid 510, or to validate the current state of the storytelling aid 510, the investigation workspace 120 may allow a user to enter a visualisation mode. The visualisation mode may limit the user's ability to make changes to the storytelling aid 510 and may also allow the user to view the storytelling aid 510 without additional GUI elements of project mode, including those associated with editing of the storytelling aid 510. As presented in the visualisation mode, the storytelling aid 510 may include, in addition to the DEFs 416A and 416B, other DEFs 542 which were added to the storytelling aid 510 within the project mode. The storytelling aid 510 may also include narrative or contextual information 544 provided by the user when in project mode, or which forms part of the case metadata 414, and other information, as appropriate. The visual arrangement of the DEFs 416A, 416B, 542 and the contextual information 544 aligns with the visual arrangement indicated by the user during the project mode, and therefore may facilitate the task of a user of the investigation workspace in explaining a sequence of events, actors in those events, the locations where those events occurred, and the like, relating to the investigation, in a clear and convincing manner. Additionally, the visualisation mode may display a chapter list 548, which may be used to cycle between the various chapters of the storytelling aid 510, which may have been established during the project mode. The chapter list 548 may indicate a current position within the chapters, as well as how many preceding and/or following chapters remain.

With additional reference to FIG. 5E, when the DEF 416A is updated, as described in relation to FIG. 4C, the update module 130, or another element of the investigation system 100, may detect the addition of the metadata elements to the DEF 416A. In some embodiments, the investigation workspace 120 may cause a popup 552 to be shown to the user, indicating that the DEF 416A has been modified. Although the popup 552 in FIG. 5E does not explicitly indicate which of the DEFs present in the storytelling aid 510 was updated, in other embodiments the popup 552 may provide an indication of which of the DEF(s) in the storytelling aid were updated, of the nature of the update, of the user which produced the update, or other audit trail information. In some other embodiments, other types of notifications may be provided: for instance, an auditory notification may be played in response to the modification. Additionally, the popup 552 or other notification may be provided during the visualisation mode and/or during the project mode, as appropriate.

With additional reference to FIG. 5F, in response to the DEF 416A being updated within the DEMS 110, the representation of the DEF 416A within the storytelling aid 510 is also updated, as illustrated by the presence of the added metadata, indicated at 562. This occurs without having to transfer data from the DEMS 110 to the investigation workspace 120, thereby reducing the risk of requiring a user to remember to transfer data from the DEMS 110 to the investigation workspace 120 in response to modifications in the former. Additionally, in some embodiments, the investigation workspace 120 may automatically reflect modifications to the DEFs within the DEMS 110 to the relevant storytelling aid 510 without prompting the user with a popup or other notification, like the popup 522. For instance, a user may interact with a GUI element 564 to indicate that they wish to have the DEFs 416A, 416B updated without notification.

Whether in project mode or visualization mode, the investigation workspace 120 may, in response to receiving user input with one of the representations of the DEFs in the storytelling aid 510, cause the DEMS 110, or a related application, to be launched to view the relevant DEF within the DEMS 110. For example, double-clicking on a DEF within the storytelling aid 510 may launch a web portal associated with the DEMS 110 to a page associated with the DEF, which may allow a user to see more information about the DEF than is visible within the storytelling aid 510. This action may also be mediated by the access permissions of the user, such that a user unauthorized to view the DEF may not be able to perform this action.

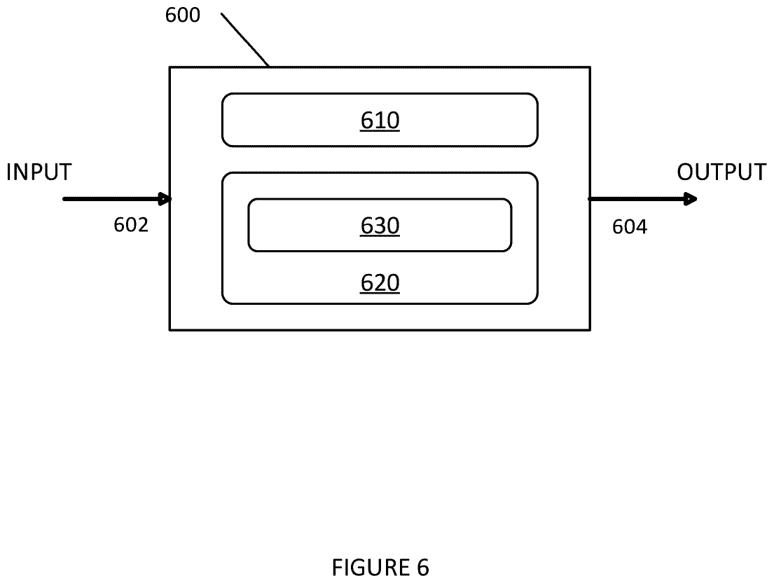

With reference to FIG. 6, there is illustrated a schematic diagram of an example computing device 600. As depicted, the computing device 600 includes at least one processor 610, a memory 620, and program instructions 630 stored within the memory 620, as well as input and output interfaces (I/O interfaces) 602 and 604, respectively. For simplicity, only one computing device 600 is shown; the various computing devices described herein may be embodied by one or more implementations of the computing device 600, which may be the same or different types of devices. For instance, the investigation workspace 120, the security device management server 150, and/or the mobile device 405 may be implemented by one or more computing devices 600. The components of the computing device 600 may be connected in various ways including directly coupled, indirectly coupled via a network, and distributed over a wide geographic area and connected via a network, for instance via a cloud computing implementation.

The I/O interfaces 602, 604 may include one or more media interfaces, via which removable media or other data sources may be coupled, one or more network interfaces, or any other suitable type of interface. The I/O interfaces 602, 604 of the computing device 600 may additionally, in some embodiments, provide interconnection functionality to one or more input devices, such as a keyboard, mouse, camera, touch screen and a microphone, or with one or more output devices such as a display screen and a speaker, for instance devices via which a user may interact with a server. In embodiments in which the I/O interfaces 602, 604 include one or more network interfaces, the network interface(s) of the computing device 600 may enable the computing device 600 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The processor 610 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. The processor 610 may be configured for executing the instructions 630 stored within the memory 620. The memory 620 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically erasable programmable read-only memory (EEPROM), Ferroelectric RAM (FRAM) or the like.

In certain embodiments, the computing device 600 is operable to register and authenticate users (using a login, unique identifier, and password for example) prior to providing access to applications, a local network, network resources, other networks, and network security devices. The computing device 600 may serve one user or multiple users.

For example, and without limitation, the computing device 600 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods and/or implementing the systems described herein.

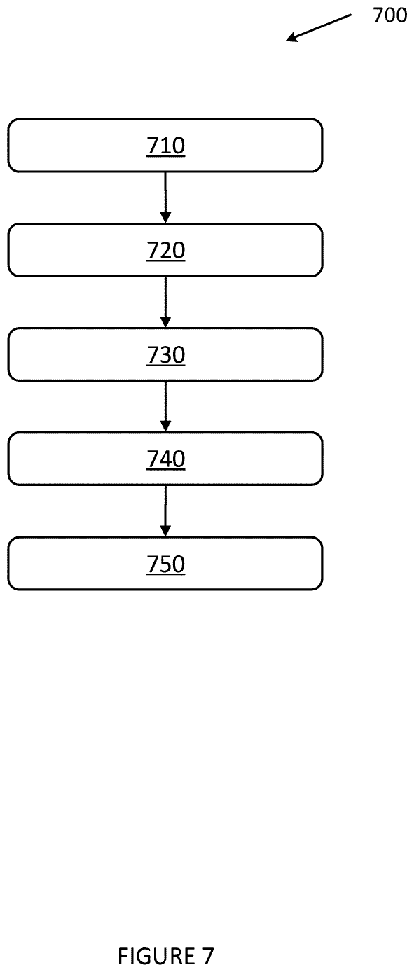

With reference to FIG. 7, there is illustrated a method 700 for maintaining an investigation workspace. The method 700 may be performed by the investigation system 100, which may be embodied as a singular computing device 600, or as a collection of multiple computing devices 600, as appropriate.

At 710, the method 700 comprises providing a first data repository, for instance the data repository 112. The data repository 112 comprises a first case database including a set of records, for instance the case records database 116, each of the records in the set of records comprising case information related to an investigation. The data repository 112 also comprises a digital evidence database, for instance the digital evidence database 114, which comprises one or more digital evidence files associated with at least one of the one or more records in the first case database, each of the one or more digital evidence files being associated with a set of metadata.

At 720, the method 700 comprises providing a second data repository accessible by an investigation workspace, for instance the data repository 122 which is accessible by the investigation workspace 120. The data repository 122 comprises a storytelling aid database, for instance the storytelling aid database 126, which includes data representative of a plurality storytelling aids and of a subset of records from the set of records of first case database (e.g., the case records database 116), each storytelling aid associated with at least one record of the subset.

At 730, the method 700 comprises storing in the second data repository (e.g., the data repository 122) an indication of a first digital evidence file in the digital evidence database of the first data repository (e.g., the data repository 112), the first digital evidence file being associated with a first record in the subset of records in the data repository 122.

At 740, the method 700 comprises detecting a modification to the set of metadata associated with the first digital evidence file, for instance by the update module 130. The detection may occur substantially in real-time with the change being made to the set of metadata, or at some later time, for instance based on a scheduled evaluation of the set of metadata stored in the first data repository (e.g., the data repository 112).

At 750, the method 700 comprises rendering, in a page in the investigation workspace (e.g., the investigation workspace 120) associated with the first record, the modification to the set of metadata associated with the first digital evidence file. This may be done by way of a popup or another visual notification, by way of an auditory notification, or the like.

The embodiments of the methods, systems, devices, and computer-readable media described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references have been made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus, if one embodiment comprises elements A, B, and C, and a second embodiment comprises elements B and D, other remaining combinations of A, B, C, or D, may also be used.

The terms “connected” or “coupled to”, as well as any similar terms, may include both direct coupling (in which two elements that are coupled to each other contact each other) and indirect coupling (in which at least one additional element is located between the two elements).

The use of numerical ranges by endpoints in the present disclosure should be understood as including all numbers within that range (e.g., 1 to 5 includes 1, 1.25, 2, 2.5, 3, 3.69, 4, 4.33, 5, etc.). Where a range of values is qualified as being “greater than”, “less than”, etc., of a particular value, that value may or may not be included within the range, as appropriate.

Any direction or orientation described in the present disclosure, including but not limited to “top”, “bottom”, “left”, “right”, “upper”, “lower”, “above”, below”, as well as other directions and orientations, are described herein for clarity, and should be understood in reference to the drawings. These and other similar terms should not be understood as limiting of an actual device or system or of use of the device or system. Many of the devices, articles, or systems described in the present disclosure may be used in a number of suitable directions and orientations.

Any citation to references in this disclosure and during the prosecution thereof is made out of an abundance of caution. No citation should be construed as an admission that the cited reference qualifies as prior art or comes from an area that is analogous or directly applicable to the present teachings.

For clarity in interpreting the claims appended hereto, and for avoidance of any misunderstanding, it is noted that none of the appended claims or elements of the appended claims, as pending or as granted, are intended to invoke 35 U.S.C. 112 (f) unless the words “means for” or “step for” are explicitly used in the particular claim or claim or claim element.

The technical solution of embodiments may be in the form of a software product. The software product may be stored in a non-volatile or non-transitory computer-readable storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and at least some of the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions, and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the examples described above and illustrated herein are intended to be examples only, and the appended claims are intended to include within their scope such processes, machines, manufacture, compositions of matter, means, methods, or steps.

Generally, all terms used in the claims are to be interpreted according to their ordinary meaning in the relevant technical field, unless explicitly defined otherwise herein. All references to a/an/the element, apparatus, component, means, step, etc., are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second”, etc. for different features/components of the present disclosure are only intended to distinguish the features/components from other similar features/components and not to impart any order or hierarchy to the features/components.

1. A computer-implemented method for maintaining an investigation workspace comprising:
providing a first data repository comprising:
a first case database including a set of records, each of the records in the set of records comprising case information related to an investigation; and
a digital evidence database comprising one or more digital evidence files associated with at least one of the one or more records in the first case database, each of the one or more digital evidence files being associated with a set of metadata;
providing a second data repository accessible by the investigation workspace, the second data repository comprising a storytelling aid database including data representative of a plurality storytelling aids and of a subset of records from the set of records of first case database, each storytelling aid associated with at least one record of the subset;
storing in the second data repository an indication of a first digital evidence file in the digital evidence database of the first data repository, the first digital evidence file being associated with a first record in the subset of records in the second data repository;
detecting a modification to the set of metadata associated with the first digital evidence file; and
rendering, in a page in the investigation workspace associated with the first record, the modification to the set of metadata associated with the first digital evidence file.

2. The method of claim 1, wherein the rendering of the modification to the set of metadata associated with the first digital evidence file comprises displaying a subset of the set of metadata associated with the at least one digital evidence file.

3. The method of claim 1, comprising rendering, in the page of the investigation workspace associated with the first record, a notification indicative of having detected the modification to the set of metadata associated with the first digital evidence file.

4. The method of claim 3, wherein rendering the notification comprises rendering, in the page in the investigation workspace associated with the first record, a graphical user interface (GUI) element indicative of the modification to the set of metadata associated with the first digital evidence file.

5. The method of claim 4, wherein the GUI element is indicative of audit trail information associated with the modification to the set of metadata associated with the first digital evidence file.

6. The method of claim 1, wherein the storing is performed in response to detecting user input indicative of a selection of the at least one digital evidence file within the investigation workspace.

7. The method of claim 6, wherein the selection is mediated by access control permissions associated with the user providing the user input.

8. The method of claim 1, wherein records in the subset of records included in the second data repository are user selected in response to further user input within the investigation workspace.

9. The method of claim 1, wherein the indication of the first digital evidence file stored in the second data repository comprises a pointer.

10. The method of claim 9, wherein the pointer comprises a uniform resource locator (URL).

11. The method of claim 1, wherein the first data repository is accessible by a digital evidence management system and the method comprises, upon detecting further user interaction with the indication of the first digital evidence file, causing the first digital evidence file to be viewable in the digital evidence management system.

12. The method of claim 1, the first data repository further comprising an audit trail database, the method further comprising generating audit trail data indicative of the at least one digital evidence file having been linked in the second data repository and storing the audit trail data in the audit trail database.

13. The method of claim 1, wherein the modification comprises an addition, a removal or a change to metadata in the set of metadata.

14. The method of claim 1, wherein the one or more digital evidence files comprise digital media files.

15. The method of claim 14, wherein the digital media files comprise video files, image files, audio files, or document files.

16. An investigation system, comprising:
a digital evidence management system providing a first data repository comprising:
a first case database including a set of records, each of the records in the set of records comprising case information related to an investigation; and
a digital evidence database comprising one or more digital evidence files associated with at least one of the one or more records in the first case database, each of the one or more digital evidence files being associated with a set of metadata;
an investigation workspace for use in generating storytelling aids, the investigation workspace providing a second data repository comprising a storytelling aid database including data representative of a plurality storytelling aids and of a subset of records from the set of records of first case database, each storytelling aid associated with at least one record of the subset, the storytelling aid database storing an indication of a first digital evidence file in the digital evidence database of the first data repository, the first digital evidence file being associated with a first record in the subset of records in the second data repository; and
a update module communicatively coupled to the digital evidence management system and to the investigation workspace and configured for:
detecting a modification to the set of metadata associated with the first digital evidence file; and
causing the investigation workspace to render, in a page in the investigation workspace associated with the first record, the modification to the set of metadata associated with the first digital evidence file.

17. The system of claim 16, wherein the update module comprises a dynamic data binder.

18. The system of claim 16, wherein the storing is performed in response to detecting user input indicative of a selection of the at least one digital evidence file within the investigation workspace.

19. The system of claim 18, wherein the selection is mediated by access control permissions associated with the user providing the user input.

20. The system of claim 16, wherein records in the subset of records included in the second data repository are user selected in response to further user input within the investigation workspace.
